(19) United States
(12) Patent Application Publication
(10) Pub. No.: US 2024/0320399 A1
(43) Pub. Date: Sep. 26, 2024

(54) REAL-TIME ESTIMATION METHOD FOR SURFACE LITHIUM CONCENTRATION OF ELECTRODE ACTIVE MATERIAL OF LITHIUM ION BATTERY

(71) Applicant: TSINGHUA UNIVERSITY, Beijing (CN)

(72) Inventors: Qixin CHEN, Beijing (CN); Yuxuan GU, Beijing (CN); Hongye GUO, Beijing (CN); Kedi ZHENG, Beijing (CN); Chongqing KANG, Beijing (CN); Qing XIA, Beijing (CN); Yuanbo CHEN, Beijing (CN)

(21) Appl. No.: 18/574,209

(22) PCT Filed: Jun. 23, 2022
(86) PCT No.: PCT/CN2022/100846

§ 371 Date: Dec. 26, 2023

(30) Foreign Application Priority Data
Jun. 29, 2021 (CN) 202110728584.4

(51) Int. Cl. G06F 30/25; H01M 10/0525

(52) U.S. Cl. CPC G06F 30/25; H01M 10/0525

(57) ABSTRACT

Provided is a real-time estimation method for a surface lithium concentration of an electrode active material of a lithium ion battery. The method comprises: obtaining an electric current sequence and a temperature sequence of a battery port and a basic parameter of an electrode active material, and calculating a surface lithium concentration, the average lithium concentration and an initial value of a transient variable of the electrode active material in a diffusion process; at the beginning of the current time period, calculating a surface reaction ion flux and a diffusion coefficient of the electrode active material and a time constant of the transient variable of lithium in the active material in the diffusion process; at the end of the current time period, calculating the transient variable of the active material in the diffusion process and the average lithium concentration of the active material.

### CROSS-REFERENCE TO RELATED APPLICATION

This application is a national stage entry under 35 U.S.C. § 371 of International Application No. PCT/CN2022/100846, filed Jun. 23, 2022, which claims priority to Chinese Patent Application No. 202110728584.4, filed Jun. 29, 2021, the entire disclosures of which are incorporated herein by reference.

### FIELD

The present disclosure belongs to the field of modeling and simulation of a lithium ion battery, and in particular relates to a real-time estimation method for a surface lithium concentration of an electrode active material of a lithium ion battery.

### BACKGROUND

In recent years, with the wide application of lithium ion batteries in electric vehicles, power grid energy storage and other fields, the demand for improving the economy and safety of batteries is increasing. To this end, it is necessary to establish a refined lithium ion battery model, so that it can accurately describe internal state changes and external output characteristics of the battery, and propose scientific and efficient management strategies based on the battery model. At present, lithium ion battery models are mainly divided into three categories. One is a model based on electrochemical mechanism, the other is an equivalent circuit model, and the third is a data-driven black box model. In practical applications, the equivalent circuit model is the most widely used. However, the essence of the equivalent circuit model is to fit external characteristics of the battery with a series of circuit elements, which is essentially data-driven. These circuit elements do not have physical meaning and the ability to describe an internal state of the battery. Therefore, the accuracy and interpretability of the model are difficult to fundamentally improve. With the higher and higher requirements for the precision of battery modeling in upper applications, merely battery models based on electrochemical mechanisms have the potential to meet these requirements. At present, the main bottleneck restricting the large-scale application of electrochemical models of the lithium ion batteries lies in their high complexity. Therefore, it is necessary to propose a technology that can effectively reduce the complexity of the electrochemical models of the lithium ion batteries, thus breaking barriers to their wide application in practical engineering.

### SUMMARY

An embodiment of the present disclosure provides a real-time estimation method for a surface lithium concentration of an electrode active material of a lithium ion battery, defining N as the number of periods of a dynamic current sequence, and t, as a length of each period in the sequence. The method includes steps (1) obtaining a current sequence and a temperature sequence of a battery; obtaining a basic parameter of the electrode active material, and calculating the surface lithium concentration and an average lithium concentration of the electrode active material and an initial value of a transient variable of the electrode active material in a diffusion process: obtaining a diffusion performance parameter of the electrode active material: (2) at a beginning of a period corresponding to a current electrode current and a temperature, calculating a surface reaction ion flux of the electrode active material: calculating a diffusion coefficient, and calculating a time constant of the transient variable of lithium in the electrode active material in the diffusion process; obtaining a function relationship between the transient variable in the diffusion process and time, obtaining a function relationship between the average lithium concentration of the electrode active material and time, and obtaining a function relationship between the surface lithium concentration of the electrode active material and time; and (3) when the period corresponding to the current electrode current and the temperature ends, calculating the transient variable of the electrode active material in the diffusion process: calculating the average lithium concentration of the electrode active material; and entering a next period, and repeating the step (2) until the current sequence ends.

### BRIEF DESCRIPTION OF THE DRAWINGS

FIG. 1 is a flow chart showing a real-time estimation method for a surface lithium concentration of an electrode active material of a lithium ion battery provided in the present disclosure.

### DETAILED DESCRIPTION

A real-time estimation method for a surface lithium concentration of an electrode active material of a lithium ion battery provided in the present disclosure is described below with reference to the accompanying drawings.

In fact, the charging and discharging process of the lithium ion battery is a process in which lithium ions diffuse from one side electrode active material particle toward the surface, migrate in an electrolyte and pass through a separator, and then intercalate and diffuse inward in the other side electrode active material particle. The diffusion of lithium ions in the active material particles determines a lithium concentration on a surface of the active material, and then directly affects the reaction rate inside the battery, which is a main phase that determines characteristics of the battery. In the classic electrochemical model of the lithium ion batteries, the diffusion of lithium ions in active materials follows Fick's second law, and the second-order partial differential equations need to be solved, which is very complicated. At present, some studies have proposed simplified methods for the diffusion of lithium in active materials. Scholars from the University of Texas at Austin used polynomial approximation to simulate the lithium ion concentration distribution in a radial direction inside the active particles (Subramanian V R. Diwakar V D. Tapriyal D. Efficient macro-micro scale coupled modeling of batteries[J]. Journal of The Electrochemical Society. 2005, 152(10): A2002-A2008.). Scholars from the University of Michigan used the Padé approximation to find a polynomial transfer function with similar frequency characteristics to the lithium ion diffusion process, and reduced model complexity by changing the order of the approximate transfer function (Forman J C. Bashash S. Stein J L. et al. Reduction of an Electrochemistry-Based Li-Ion Battery Model via Quasi-Linearization and Pade Approximation[J]. Journal of The Electrochemical Society. 2011, 158(2): A93-A101.).

To sum up, the existing research on simplifying the diffusion process of lithium ions in electrode active materials is mainly divided into two ideas. One is to fit the lithium concentration distribution through empirical formulas in a time domain, and the other is to find similar transfer functions in a frequency domain and then map them back to the time domain. The problem of the former is that empirical formulas are often related to materials used in electrode active materials. With the continuous progress of lithium ion battery production process, the electrode active materials are developing in a direction of multi-material doping. The empirical formulas with fixed parameters do not have the flexibility to apply to a wide range of active materials. The problem of the latter is that the approximate transfer function in the frequency domain needs to consider the concentration of the active material particles in each radial direction. In fact, an average lithium concentration and a surface lithium concentration of the active material particles mainly affect the battery characteristics. The approximation method in the frequency domain need to take into account the concentration in each radial direction, which is the result of balanced consideration of the accuracy of each place, and it is difficult to specifically ensure the high accuracy of the average lithium concentration and the surface lithium concentration. Therefore, the estimation method for the surface lithium concentration of the electrode active material of the lithium ion battery not only needs to be flexible and easy to migrate to different electrode materials, but also needs to ensure the accuracy of the average lithium concentration and the surface lithium concentration under the condition of simple calculation. Background art related to the present disclosure includes the following four (1) to (4).

(1) Measurement of the electrode equilibrium potential function: the electrode equilibrium potential function U_{OCP}=f(x;T) reflects thermodynamic characteristics of the lithium ion de-intercalation chemical reaction on an electrode surface, also known as an electrode equilibrium potential. The measurement method is as follows. The electrode material is prepared into a pole piece, which is assembled with a metal lithium piece to form a button half-cell, and then it is charged and discharged circularly with a small current. An overall U_{OCP}=f (x;T) curve may be obtained by measuring an open circuit voltage of the electrode material in different states of charge (x∈[0, 1]) and different temperatures. For more information on the method of measuring the electrode equilibrium potential function, see Lei, H. and Han, Y. Y. The measurement and analysis for Open Circuit Voltage of Lithium-ion Battery [J]. In Journal of Physics: Conference Series (Vol. 1325, No. 1, p. 012173). IOP Publishing.

(2) Nonlinear equation solving technology: since the equilibrium potential function is generally a nonlinear function, solving an initial value x₀=f⁻¹ (V₀;T₁) of the lithium intercalation rate of the electrode active material involves solving the nonlinear equations. One-variable nonlinear equations can be solved by the bisection method or the Newton's method.

(3) Parameter identification technology: the parameter identification technology is to determine parameter values of a set of models according to the experimental data and the established model, so that numerical results calculated by the model can best fit test data. In the method of the embodiment of the present disclosure, electrode diffusion parameters Rₛ, λₛ, k₈, E_{A}, g(x;T_{ref}) are determined by the electrode material. For new electrode materials, these parameters are unknown. These parameters can be obtained from data obtained from electrode tests by using parameter identification technology.

(4) Calculation model of reaction ion flux: the electrochemical model of lithium ion battery can calculate the reaction ion flux on the surface of the active material according to variables such as the surface lithium concentration, a temperature, and a port current of the active material: jₙ=h(c_{s,surf}, T,I). The specific solving method depends on the adopted electrochemical model. Taking the uniform reaction ion flux model as an example, for negative active materials, there are:

$${j}_{n} = \frac{{IR}_{s}}{3 AL {ε}_{s} F}$$

for positive electrode active materials, there are:

$${j}_{n} = - \frac{{IR}_{s}}{3 AL {ε}_{s} F}$$

where A is a cross-sectional area of the electrode, L is a thickness of the electrode, F is the Faraday constant, and εₛ is a volume fraction of the active material in the whole electrode. For the calculation method of the uniform reaction ion flux model, see Ríos-Alborés, A. and Rodríguez, J., Single Particle Models for the Numerical Simulation of Lithium-Ion Cells [M]. Advances on Links Between Mathematics and Industry: CTMI 2019, p. 91.

The purpose of the present disclosure is to solve the problem that it is difficult to simply estimate a surface lithium concentration of an electrode active material of a lithium ion battery, reduce the complexity of an electrochemical model of the lithium ion battery, and improve the universality of the model. According to the diffusion law and characteristics of lithium ions in the electrode active material, a diffusion process of the lithium ion in a radial direction of the electrode active material is modeled as a superposition of a first-order transient process and transitory process. The surface lithium concentration of the electrode active material can be obtained directly from an average lithium concentration plus transient variables and transitory variables, thus avoiding the solution of high-order partial differential equations and realizing the state equation of the model. By discretizing a battery dynamic temperature and a current sequence as model input, the surface lithium concentration of the electrode active material at any time can be directly obtained. In method embodiments of the present disclosure, diffusion performance parameters of the electrode materials can be obtained by analyzing experimental data of the electrodes through a data-driven parameter estimation method. Therefore, the method has universality for electrodes composed of different electrode active materials.

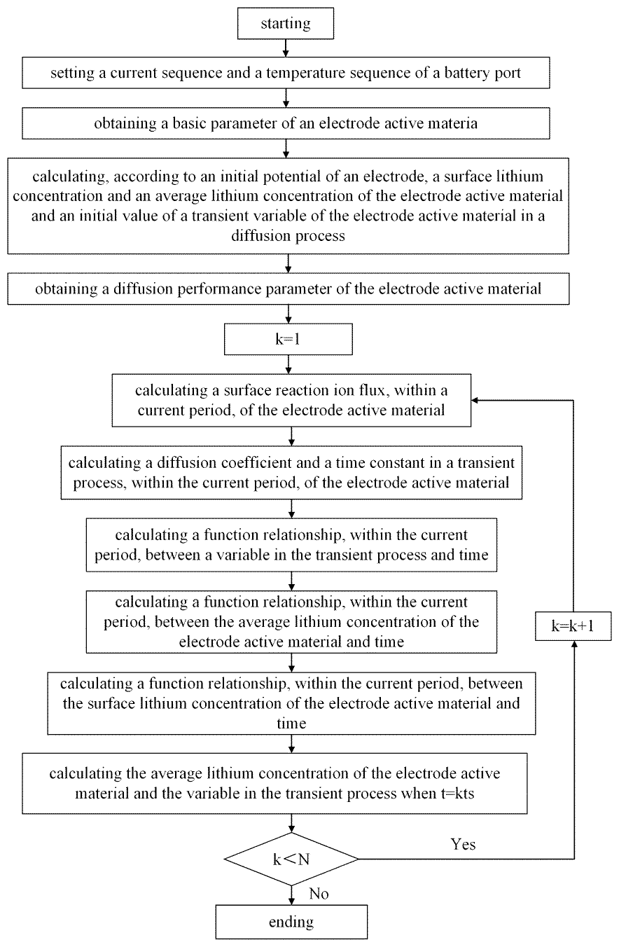

As shown in FIG. 1, this method defines N as the number of periods of a dynamic current sequence, and tₛ as a length of each period in the sequence. The implementation flow chart of the method is shown in FIG. 1, and the method specifically includes steps (1), (2) and (3).

(1) A current sequence and a temperature sequence of a battery are obtained. A basic parameter of the electrode active material is obtained. The surface lithium concentration and an average lithium concentration of the electrode active material and an initial value of a transient variable of the electrode active material in a diffusion process are calculated. A diffusion performance parameter of the electrode active material is obtained. The step (1) specifically includes steps (1.1), (1.2), and (1.3).

(1.1) The current sequence of the battery port and a temperature sequence of an environment where the battery port is located are set, respectively represented by:

$$I = [ \begin{matrix}{I}_{1} & {I}_{2} & … & {I}_{k} & … & {I}_{N}\end{matrix} ] , T = [ \begin{matrix}{T}_{1} & {T}_{2} & … & {T}_{k} & … & {T}_{N}\end{matrix} ]$$

where an electric current Iₖ and a temperature Tₖ are active during a period of (k−1)tₛ≤t≤ktₛ, and it is specified that a sign of the electric current is positive when the battery is discharged, and negative when the battery is charged.

(1.2) A type of the electrode active material used for an electrode to be analyzed is obtained. A function relationship between a reaction equilibrium potential of the electrode active material and a lithium intercalation rate and an electrode temperature is queried: U_{OCP}=f(x;T) (this function can be obtained from electrode tests). A potential V₀ of the electrode relative to a reference electrode is measured to obtain an initial lithium intercalation rate x₀=f⁻¹(V₀;T₁) of the electrode active material. A maximum lithium concentration cₛ^{max}=ρ/M that can be accommodated by the electrode active material is calculated, where ρ is a density of the electrode active material, and M is the relative molar mass of the electrode active material. Basic parameters of common electrode active materials for lithium ion batteries are shown in Table 1. At an initial stage, the surface lithium concentration of the electrode active material is equal to the average lithium concentration of the electrode active material: c_{s,surf}(0)=c_{s,av}(0)=c_{d}^{max}x₀. The transient variable of the electrode active material in the diffusion process is zero: ω(0)=0.

TABLE 1
Basic parameters of common electrode active
materials for lithium ion batteries

| | | Relative |
|---|---|---|
| | Density | molar mass |
| Active materials | (g/cm³) | (g/mol) |
| Graphite negative electrode (GRAPHITE) | 2.24 | 72.06 |
| Ternary positive electrode (NCM523) | 4.8 | 96.554 |
| Ternary positive electrode (NCM811) | 4.8 | 97.28 |
| Iron Phosphate Cathode (LFPO) | 3.6 | 157.751 |

(1.3) A diffusion performance parameter of the electrode active material used for the electrode to be analyzed is obtained. A particle radius of the electrode active material is denoted as Rₛ. A proportion of a transient phase to the diffusion process is denoted as λₛ. A time constant correction coefficient of the transient phase is denoted as kₛ. A function relationship between a diffusion coefficient of the electrode active material and a lithium intercalation rate in a standard state is obtained: D_{s,ref}=g(x;T_{ref}). An activation energy E_{A} of a diffusion process coefficient of the electrode active material is obtained. Diffusion performance parameters of common electrode active materials for the lithium ion batteries are shown in Table 2. Rₛ, λₛ, kₛ, E_{A}, and g(x;T_{ref}) can also be obtained by a data-driven parameter estimation method after the electrode tests.

TABLE 2
Diffusion performance parameters of common electrode
active materials for the lithium ion batteries

| | | Proportion of a | Time constant | Activation energy |
|---|---|---|---|---|
| | | transient phase | correction | of a diffusion |
| | Particle | to a diffusion | coefficient of the | coefficient |
| Active materials | radius (m) | process | transient phase | (KJ/mol) |
| Graphite negative | 1.5 × 1e−5 | 9/10 | 1/37 | 29.553 |
| electrode (GRAPHITE) | | | | |
| Ternary positive | 1 × 1e−5 | 6/7 | 1/30 | −32.349 |
| electrode (NCM523) | | | | |
| Ternary positive | 1 × 1e−5 | 6/7 | 1/30 | −32.349 |
| electrode (NCM811) | | | | |
| Iron Phosphate | 1.04 × 1e−7 | 11/14 | 1/35 | 29.995 |
| Cathode (LFPO) | | | | |

| | |
|---|---|
| Active materials | diffusion coefficient and lithium intercalation rate function |
| | D_{s, ref} = g(x; T_{ref}) |
| Graphite negative | D_{s, ref} = −2.47 × 10⁻¹⁴x + 2.94 × 10⁻¹⁴ |
| electrode (GRAPHITE) | |
| Ternary positive | D_{s, ref} = −1.99 × 10⁻¹⁴x + 2.63 × 10⁻¹⁴ |
| electrode (NCM523) | |
| Ternary positive | D_{s, ref} = −2 × 10⁻¹⁴x + 2.64 × 10⁻¹⁴ |
| electrode (NCM811) | |
| Iron Phosphate | D_{s, ref} = 8.25 × 10⁻¹⁸ |
| Cathode (LFPO) | |

Note:
The parameters in this table are only illustrative, and the actual parameters need to be estimated from electrode tests data.

(2) At a beginning of a period corresponding to a current electrode current and a temperature, a surface reaction ion flux of the electrode active material is calculated. A diffusion coefficient is calculated. A time constant of the transient variable of lithium in the electrode active material in the diffusion process is calculated. A function relationship between the transient variable in the diffusion process and time is obtained. A function relationship between the average lithium concentration of the electrode active material and time is obtained. A function relationship between the surface lithium concentration of the electrode active material and time is obtained. The step (1) specifically includes steps (2.1) to (2.5).

(2.1) It is assumed that a current period is k, that is, a stage of (k−1)tₛ≤t≤ktₛ, the electric current acting on the battery is Iₖ, the temperature is Tₖ. The surface lithium concentration of the electrode active material is c_{,surf}(k−1)tₛ) when t=(k−1)tₛ. The surface reaction ion flux of the electrode active material in the period is calculated according to an existing analytical formula jₙ=h(c_{s,surf},T,I) (a specific form of the analytical formula depends on a calculation model of the reaction ion flux adopted):

$${j}_{n , k} = h ( {c}_{s , surf} ( ( k - 1 ) {t}_{s} ) , {T}_{k} , {I}_{k} ) .$$

(2.2) When t=(k−1)tₛ, the average lithium concentration of the electrode active material is c_{s,av}(k−1)tₛ) and an average lithium intercalation rate of the electrode active material is x((k−1)tₛ)=c_{s,av}((k−1)tₛ)/cₛ^{max}, the diffusion coefficient at this time is calculated:

$${D}_{s , k} = exp ( - {E}_{A} / R / {T}_{k} + {E}_{A} / R / {T}_{r e f} + ln ( g ( x ( ( k - 1 ) {t}_{s} ) ; {T}_{ref} ) ) )$$

where the ideal gas constant is R=8.314, the time constant of the transient variable of lithium in the electrode active material in the diffusion process is calculated:

$${τ}_{s , k} = {k}_{s} \frac{{R}_{s}^{2}}{{D}_{s , k}} .$$

(2.3) In a period of (k−1)tₛ≤t≤ktₛ, the function relationship between the transient variable in the diffusion process and the time is:

$$w ( t ) = w ( ( k - 1 ) {t}_{s} ) exp ( - \frac{( t - ( k - 1 ) {t}_{s} )}{{τ}_{s}} ) - \frac{{λ}_{δ} {R}_{s}}{5 {D}_{s , k}} {j}_{n , k} ( 1 - exp ( - \frac{( t - ( k - 1 ) {t}_{s} )}{{τ}_{s}} ) ) .$$

(2.4) In the period of (k−1)tₛ≤t≤ktₛ, the function relationship between the average lithium concentration of the electrode active material and the time is:

$${c}_{s , av} ( t ) = {c}_{s , av} ( ( k - 1 ) {t}_{s} ) - \frac{{R}_{s} ( t - ( k - 1 ) {t}_{s} )}{3} {j}_{n , k}$$

the average lithium concentration at any time in the period being thus estimated by the above formula.

(2.5) In the period of (k−1)tₛ≤t≤ktₛ, the function relationship between the surface lithium concentration of the electrode active material and the time is:

$${c}_{s , surf} ( t ) = {c}_{s , a v} ( t ) + w ( t ) - \frac{( 1 - {λ}_{s} ) {R}_{s}}{5 {D}_{s , k}} {j}_{n , k}$$

the surface lithium concentration at any time in the period being thus estimated by the above formula.

(3) When the period corresponding to the current electrode current and the temperature ends, the transient variable of the electrode active material in the diffusion process is calculated. The average lithium concentration of the electrode active material is calculated. Enter a next period, and the step (2) is repeated until the current sequence ends. The step (3) specifically includes steps (3.1), and (3.2).

(3.1) It is assumed that a current period is k, that is, a stage of (k−1)tₛ≤t≤ktₛ, when t=ktₛ, a value of the transient variable in the diffusion process is calculated as an initial value in the next period:

$$w ( k {t}_{s} ) = w ( ( k - 1 ) {t}_{s} ) exp ( - \frac{{t}_{s}}{{τ}_{s}} ) - \frac{{λ}_{s} {R}_{s}}{5 {D}_{s , k}} {j}_{n , k} ( 1 - exp ( - \frac{{t}_{s}}{{τ}_{s}} ) )$$

a value of the average lithium concentration of the electrode active material being calculated as an initial value in the next stage:

$${c}_{s , a v} ( k {t}_{s} ) = {c}_{s , a v} ( ( k - 1 ) {t}_{s} ) - \frac{{R}_{s} {t}_{s}}{3} {j}_{n , k} .$$

(3.2) The step (2) is repeated until the current sequence and the temperature sequence end.

Although the embodiments of the present disclosure have been shown and described above, it is to be understood that the above embodiments are illustrative and cannot be construed as limiting the present disclosure, and those skilled in the art may make changes, modifications, substitutions, and variations to the above embodiments within the scope of the present disclosure.

Technical features and beneficial effects of the present disclosure are as follows. The present disclosure realizes the real-time estimation method for the surface lithium concentration of the electrode active material of the lithium ion battery at the dynamic current and temperature. The method provided in the embodiments of the present disclosure can be applied to battery electrodes composed of different electrode active materials and retains dynamic characteristics of the radial diffusion of lithium ions in the electrode active material at little computational cost simultaneously compared with existing methods. By applying the above-mentioned method, the complexity of an electrode part in the electrochemical model of the lithium ion battery can be greatly reduced, and the practicability of the electrochemical model can be improved, which has important practical significance and good application prospects.

1. A real-time estimation method for a surface lithium concentration of an electrode active material of a lithium ion battery, defining N as a number of periods of a dynamic current sequence, and t, as a length of each period in the sequence; comprising steps:
(1) obtaining a current sequence and a temperature sequence of a battery port; obtaining a basic parameter of the electrode active material, and calculating the surface lithium concentration and an average lithium concentration of the electrode active material and an initial value of a transient variable of the electrode active material in a diffusion process; obtaining a diffusion performance parameter of the electrode active material;
(2) at a beginning of a period corresponding to a current electrode current and a temperature, calculating a surface reaction ion flux of the electrode active material; calculating a diffusion coefficient, and calculating a time constant of the transient variable of lithium in the electrode active material in the diffusion process; obtaining a function relationship between the transient variable in the diffusion process and time, obtaining a function relationship between the average lithium concentration of the electrode active material and time, and obtaining a function relationship between the surface lithium concentration of the electrode active material and time; and
(3) when the period corresponding to the current electrode current and the temperature ends, calculating the transient variable of the electrode active material in the diffusion process; calculating the average lithium concentration of the electrode active material; and entering a next period, and repeating the step (2) until the current sequence ends.

2. The real-time estimation method for the surface lithium concentration of the electrode active material of the lithium ion battery of claim 1, wherein step (1) comprises:
(1.1) setting the current sequence of the battery port and a temperature sequence of an environment where the battery port is located, respectively represented by:
$$I = [ {I}_{1} {I}_{2} … {I}_{k} … {I}_{N} ] , T = [ {T}_{1} {T}_{2} … {T}_{k} … {T}_{N} ]$$
where an electric current Iₖ and a temperature Tₖ are active during a period of (k−1)tₛ≤t≤ktₛ, and it is specified that a sign of the electric current is positive when the battery is discharged, and negative when the battery is charged;
(1.2) obtaining a type of the electrode active material used for an electrode to be analyzed, querying a function relationship between a reaction equilibrium potential of the electrode active material and a lithium intercalation rate and an electrode temperature: U_{OCP}=f (x;T), measuring a potential V₀ of the electrode relative to a reference electrode to obtain an initial lithium intercalation rate x₀=f⁻¹(V₀;T₁) of the electrode active material, and calculating a maximum lithium concentration cₛ^{max}=ρ/M that can be accommodated by the electrode active material;
where ρ is a density of the electrode active material, and M is the relative molar mass of the electrode active material; at an initial stage, the surface lithium concentration of the electrode active material is equal to the average lithium concentration of the electrode active material: c_{s,surf}(0)=c_{s,av}(0)=cₛ^{max}x₀, and the transient variable of the electrode active material in the diffusion process is zero: ω(0)=0; and
(1.3) obtaining a diffusion performance parameter of the electrode active material used for the electrode to be analyzed, denoting a particle radius of the electrode active material as Rₛ, a proportion of a transient phase to the diffusion process as λₛ, and a time constant correction coefficient of the transient phase as kₛ, obtaining a function relationship between a diffusion coefficient of the electrode active material and a lithium intercalation rate in a standard state: D_{s,ref}=g(x;T_{ref}); and obtaining an activation energy E_{A} of a diffusion process coefficient of the electrode active material.

3. The real-time estimation method for the surface lithium concentration of the electrode active material of the lithium ion battery of claim 1, wherein step (2) comprises:
(2.1) assuming that a current period is k, that is, a stage of (k−1)tₛ≤t≤ktₛ, the electric current acting on the battery is Iₖ, the temperature is Tₖ, and the surface lithium concentration of the electrode active material is c_{s,surf}((k−1)tₛ) when t=(k−1)tₛ, calculating the surface reaction ion flux of the electrode active material in the period according to an existing analytical formula jₙ=h(c_{s,surf}, T, I):
$${j}_{n , k} = h ( {c}_{s , surf} ( ( k - 1 ) {t}_{s} ) , {T}_{k} , {I}_{k} ) ;$$
(2.2) when t=(k−1)tₛ, the average lithium concentration of the electrode active material being c_{s,av}((k−1)tₛ) and an average lithium intercalation rate of the electrode active material being x((k−1)tₛ)=c_{s,av}((k−1)tₛ)/cₛ^{max}, calculating the diffusion coefficient at this time:
$${D}_{s , k} = exp ( - {E}_{A} / R / {T}_{k} + {E}_{A} / R / {T}_{r e f} + ln ( g ( x ( ( k - 1 ) {t}_{s} ) ; {T}_{r e f} ) ) )$$
where the ideal gas constant is R=8.314, calculating the time constant of the transient variable of lithium in the electrode active material in the diffusion process:
$${τ}_{s , k} = {k}_{s} \frac{{R}_{s}^{2}}{{D}_{s , k}} ;$$
(2.3) in a period of (k−1)tₛ≤t≤ktₛ, the function relationship between the transient variable in the diffusion process and the time being:
$$w ( t ) = w ( ( k - 1 ) {t}_{s} ) exp ( - \frac{( t - ( k - 1 ) {t}_{s} )}{{τ}_{s}} ) - \frac{{λ}_{s} {R}_{s}}{5 {D}_{s , k}} {j}_{n , k} ( 1 - exp ( - \frac{( t - ( k - 1 ) {t}_{s} )}{{τ}_{s}} ) ) ;$$
(2.4) in the period of (k−1)tₛ≤t≤ktₛ, the function relationship between the average lithium concentration of the electrode active material and the time being:
$${c}_{s , a v} ( t ) = {c}_{s , av} ( ( k - 1 ) {t}_{s} ) - \frac{{R}_{s} ( t - ( k - 1 ) {t}_{s} )}{3} {j}_{n , k}$$
where the average lithium concentration at any time in the period being thus estimated by the above formula; and
(2.5) in the period of (k−1)tₛ≤t≤ktₛ, the function relationship between the surface lithium concentration of the electrode active material and the time being:
$${c}_{s , surf} ( t ) = {c}_{s , av} ( t ) + w ( t ) - \frac{( 1 - {λ}_{s} ) {R}_{s}}{5 {D}_{s , k}} {j}_{n , k}$$
where the surface lithium concentration at any time in the period being thus estimated by the above formula.

4. The real-time estimation method for the surface lithium concentration of the electrode active material of the lithium ion battery of claim 1, wherein step (3) comprises:
(3.1) assuming that a current period is k, that is, a stage of (k−1)tₛ≤t≤ktₛ, when t=ktₛ, calculating a value of the transient variable in the diffusion process as an initial value in the next period:
$$w ( k {t}_{s} ) = w ( ( k - 1 ) {t}_{s} ) exp ( - \frac{{t}_{s}}{{τ}_{s}} ) - \frac{{λ}_{s} {R}_{s}}{5 {D}_{s , k}} {j}_{n , k} ( 1 - exp ( - \frac{{t}_{s}}{{τ}_{s}} ) )$$
calculating a value of the average lithium concentration of the electrode active material as an initial value in the next stage:
$${c}_{s , av} ( k {t}_{s} ) = {c}_{s , a v} ( ( k - 1 ) {t}_{s} ) - \frac{{R}_{s} {t}_{s}}{3} {j}_{n , k} ;$$
and
(3.2) repeating the step (2) until the current sequence and the temperature sequence end.
